(19) United States
(12) Patent Application Publication
(10) Pub. No.: US 2016/0041645 A1
(43) Pub. Date: Feb. 11, 2016

(54) TOUCHSCREEN DEVICE, METHOD OF SENSING TOUCH INTERACTION, METHOD OF GENERATING DRIVING SIGNALS, AND METHOD OF CREATING DRIVING MATRIX

(71) Applicant: SAMSUNG ELECTRO-MECHANICS CO., LTD., Suwon-si (KR)

(72) Inventors: Amiya RAY, Suwon-Si (KR); Hyun Suk LEE, Suwon-Si (KR)

(73) Assignee: SAMSUNG ELECTRO-MECHANICS CO., LTD., Suwon-si (KR)

(21) Appl. No.: 14/671,065

(22) Filed: Mar. 27, 2015

(30) Foreign Application Priority Data
Aug. 8, 2014 (KR) 10-2014-0102410

(51) Int. Cl. G06F 3/044

(52) U.S. Cl. CPC G06F 3/044

(57) ABSTRACT

A touchscreen device may include a driving circuit unit simultaneously applying predetermined driving signals to N first electrodes among a plurality of first electrodes, N being a natural number equal to or greater than two, a sensing circuit unit detecting levels of capacitance from a plurality of second electrodes to output sensing signals, and an operation unit determining an occurrence of a touch interaction, based on the sensing signals. The driving circuit unit determines at least one column in which a sum of elements is equal to a peak value, selects one row having a highest number of elements having a maximum level from rows of the at least one column, creates a first matrix by inverting levels of elements in the selected row, and generates the driving signals according to a driving matrix created based on the first matrix.

### CROSS-REFERENCE TO RELATED APPLICATION

This application claims priority to, and the benefit of, Korean Patent Application No. 10-2014-0102410 filed on Aug. 8, 2014, with the Korean Intellectual Property Office, the disclosure of which is incorporated herein by reference.

### BACKGROUND

The present disclosure relates to a touchscreen device, a method of sensing a touch interaction, a method of generating driving signals, and a method of creating a driving matrix.

Touchscreen devices, such as touchscreens and touch pads, are data input devices attached to display devices so as to provide an intuitive user interface in electronic products, and such touchscreen devices have been widely applied to various electronic devices such as cellular phones, personal digital assistants (PDAs), and navigation devices. Particularly, as demand for smartphones has increased, touchscreens have been increasingly employed as devices providing various input methods to users in a limited form factor.

Touchscreens used in portable devices may be mainly divided into resistive type touchscreens and capacitive type touchscreens, depending on the manner in which touch interactions are sensed thereby. Here, the capacitive type touchscreens have the advantages of relatively long lifespans and ease in the sensing of various input contacts and gestures, and thus has been increasingly employed in electronic devices. The implementation of a multi-touch interface in capacitive type touchscreens is particularly easy as compared to resistive type touchscreens, and thus, capacitive type touchscreens are widely used in smartphones and the like.

Capacitive type touchscreens commonly include a plurality of electrodes having a predetermined pattern, and the electrodes define a plurality of nodes in which changes in capacitance are generated by touch interactions. In the plurality of nodes arranged on a two-dimensional plane, changes in self-capacitance or in mutual-capacitance are generated by a touch interaction, and coordinates of the touch interaction may be calculated by applying, for example, a weighted average method to the changes in capacitance generated in the plurality of nodes.

Touchscreen devices have been employed in laptop computers, TVs and the like, having large screens, as well as in small mobile devices. As the size of the touchscreen devices has increased, the number and the size of electrodes have also increased. Accordingly, when driving signals are sequentially applied to a plurality of electrodes, capacitance increased proportionally to the increased number of electrodes and the increased size of the electrodes, so that the time for charging voltage, i.e., the driving time is increased.

### RELATED ART DOCUMENT

(Patent Document 1) Japanese Patent Laid-Open Publication No. 2013-149223

### SUMMARY

An aspect of the present disclosure may provide a touchscreen device having a shortened driving time.

According to an aspect of the present disclosure, a touchscreen device may include: a driving circuit unit simultaneously applying predetermined driving signals to N first electrodes among a plurality of first electrodes provided on a panel unit, where N is a natural number equal to or greater than two; a sensing circuit unit detecting levels of capacitance from a plurality of second electrodes provided on the panel unit to output sensing signals; and an operation unit determining an occurrence of a touch interaction, based on the sensing signals, wherein the driving circuit unit is configured to determine at least one column in which a sum of elements thereof is equal to a peak value among columns of an N-by-N basic matrix, select one row having a highest number of elements having a maximum level from rows of the determined at least one column, then create a first matrix by inverting levels of elements in the selected one row, and generate the driving signals according to a driving matrix created based on the first matrix.

According to another aspect of the present disclosure, a method of generating driving signals may include: determining at least one column in which a sum of elements thereof is equal to a peak value among columns of an N-by-N basic matrix, and selecting one row having a highest number of elements having a maximum level from the determined at least one column; creating a first matrix by inverting levels of elements in the selected one row; creating a driving matrix from the first matrix; and generating a driving signal according to the driving matrix.

According to another aspect of the present disclosure, a method of creating a driving matrix may include: creating a first matrix by inverting elements in one row depending on sums of elements in columns of an N-by-N basic matrix; creating a second matrix from the first matrix by determining whether a column in which a sum of elements thereof is a negative value is present among the columns of the first matrix; and determining the second matrix as a driving matrix depending on the sums of elements in columns of the second matrix.

According to another aspect of the present disclosure, a method of sensing a touch interaction may include: applying driving signals generated according to a driving matrix to N first electrodes among a plurality of first electrodes, where N is a natural number equal to or greater than two; obtaining sensing signals from second electrodes intersecting the plurality of first electrodes; and determining an occurrence of a touch interaction by calculating a correlation value between the sensing signals and the driving signals.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view showing an outer casing of an electronic device including a touchscreen device according to an exemplary embodiment in the present disclosure;

FIG. 2 is a view of a panel unit included in a touchscreen device according to an exemplary embodiment in the present disclosure;

FIG. 3 is a cross-sectional view of a panel unit included in a touchscreen device according to an exemplary embodiment in the present disclosure;

FIG. 4 is a diagram illustrating a touchscreen device according to an exemplary embodiment in the present disclosure;

FIG. 5 is a view schematically illustrating a touchscreen device according to the exemplary embodiment in FIG. 4;

FIG. 6 is a driving matrix for generating driving signals according to an exemplary embodiment in the present disclosure;

FIGS. 7 through 9 are diagrams for illustrating a process to create a basic matrix according to an exemplary embodiment in the present disclosure;

FIGS. 10 and 11 are diagrams for illustrating a process to create a basic matrix according to another exemplary embodiment in the present disclosure; and

FIG. 12 is a flow chart for illustrating a method of generating driving signals according to an exemplary embodiment in the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

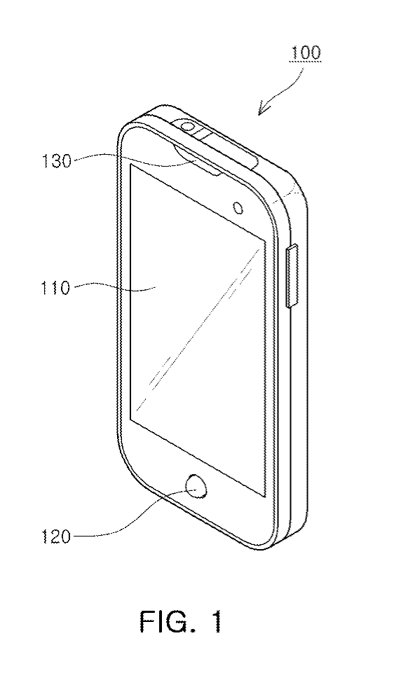

FIG. 1 is a perspective view showing an outer casing of an electronic device including a touch panel according to an exemplary embodiment in the present disclosure.

Referring to FIG. 1, the electronic device 100 according to an exemplary embodiment may include a display device 110 for displaying a screen, an input unit 120, an audio unit 130 for outputting sound, and a touchscreen device (not shown) integrated with the display device 110. A touch panel may be included in the touchscreen device.

The touchscreen device may include a touch panel having a substrate and a plurality of electrodes provided on the substrate. Further, the touchscreen device may include a controller integrated circuit (touch sensing device) that includes a capacitance sensing circuit to sense a change in the capacitance generated in the plurality of electrodes, an analog-digital converting circuit to convert an output signal from the capacitance sensing circuit into a digital value, and a calculating circuit to determine an occurrence of a touch interaction, based on the converted data of the digital value.

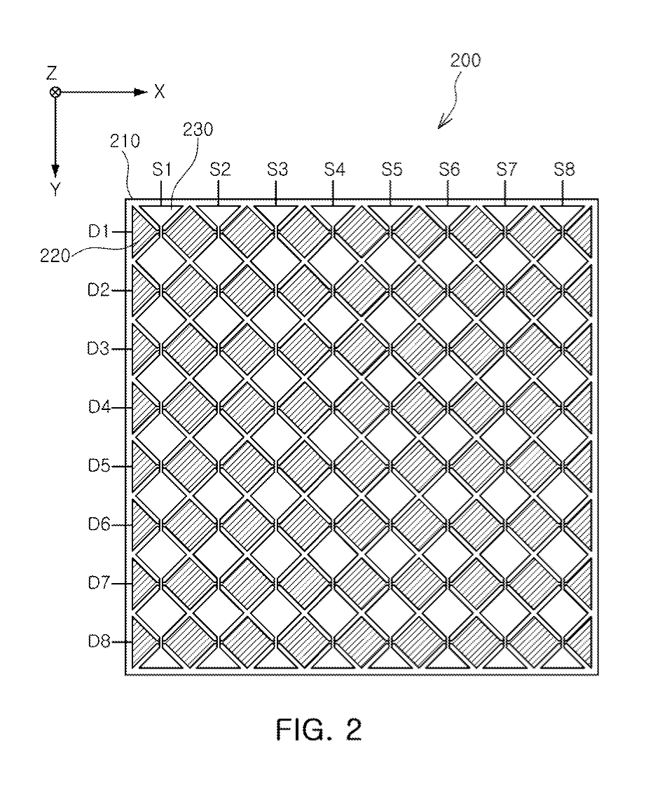

FIG. 2 is a view of a panel unit included in a touchscreen device according to an exemplary embodiment in the present disclosure.

Referring to FIG. 2, the panel unit 200 according to the exemplary embodiment includes a substrate 210 and a plurality of electrodes 220 and 230 provided on the substrate 210. Although not shown in FIG. 2, each of the pluralities of electrodes 220 and 230 may be electrically connected to a wiring pattern on a circuit board attached to one end of the substrate 210 through a wiring and a bonding pad. A controller integrated circuit may be mounted on the circuit board so as to detect sensing signals generated in the pluralities of electrodes 220 and 230 and may determine an occurrence of a touch interaction, based on the detected sensing signals.

The substrate 210 may be formed of films such as polyethylene terephthalate (PET), polycarbonate (PC), polyethersulfone (PES), polyimide (PI), polymethylmethacrylate (PMMA), and cyclo-olefin polymer (COP), or may be formed of materials such as soda glass and tempered glass.

The pluralities of electrodes 220 and 230 may be formed on one surface or both surfaces of the substrate 210. Although the plurality of electrodes 220 and 230 are shown to have a lozenge- or diamond-shaped pattern in FIG. 2, it is apparent that the plurality of electrodes 220 and 230 may have patterns of a variety of polygonal shapes such as rectangle and triangle.

The pluralities of electrodes 220 and 230 may include first electrodes 220 extending in the x-axis direction, and second electrodes 230 extending in the y-axis direction. The first electrodes 220 and the second electrodes 230 may be provided on both surfaces of the substrate 210 or may be provided on different substrates 210 such that they may intersect with each other. When all of the first electrodes 220 and the second electrodes 230 are provided on one surface of the substrate 210, an insulating layer may be partially formed at intersection points between the first electrodes 220 and the second electrodes 230.

On the regions in which wiring connecting to the plurality of electrodes 220 and 230 is provided other than the region in which the plurality of electrodes 220 and 230 is formed, a printed region may be formed on the region of the substrate 210 so as to hide the wiring typically formed of an opaque metal material.

A device, which is electrically connected to the pluralities of electrodes 220 and 230 to sense a touch interaction, detects changes in capacitance generated in the plurality of electrodes 220 and 230 by a touch interaction to sense the touch interaction based on the detected change in capacitance. The first electrodes 220 may be connected to channels defined as D1 to D8 in the controller integrated circuit to receive predetermined driving signals, and the second electrodes 230 may be connected to channels defined as S1 to S8 to be used by the touch sensing device to detect a sensing signal. The controller integrated circuit may detect a change in mutual-capacitance generated between the first electrodes 220 and the second electrodes 230 as the sensing signal.

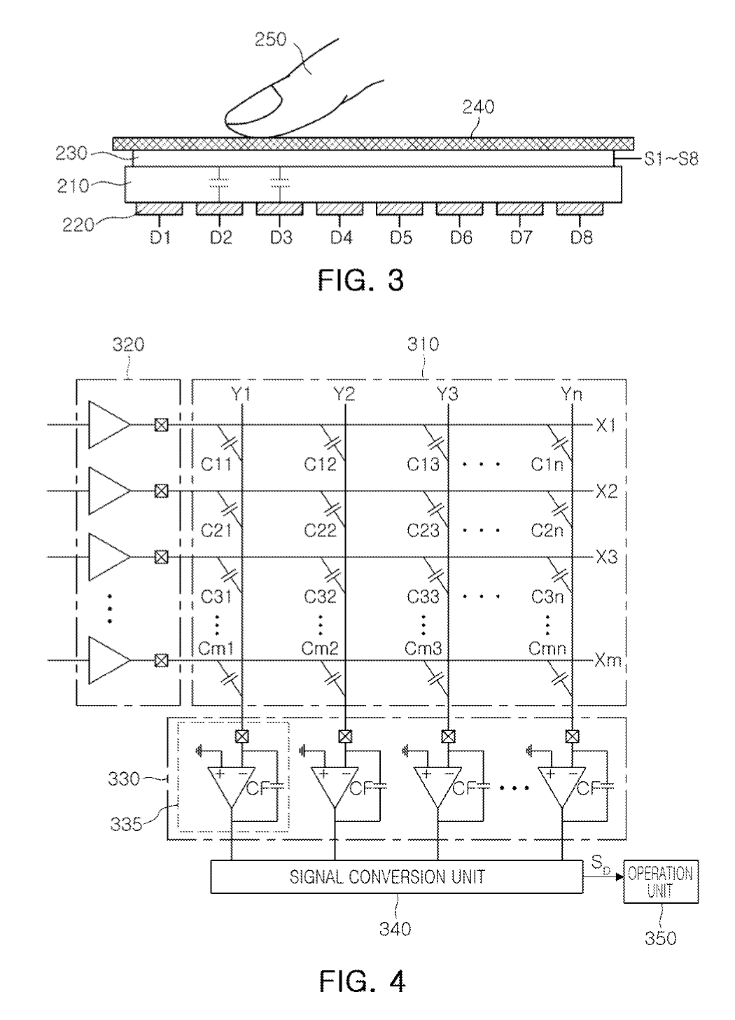

FIG. 3 is a cross-sectional view of a panel unit included in a touchscreen device according to an exemplary embodiment in the present disclosure. FIG. 3 is a cross-sectional view of the panel unit 200 illustrated in FIG. 2 taken in the y-z plane, in which the panel unit 200 may further include a cover lens 240 that is touched, in addition to the substrate 210 and the pluralities of sensing electrodes 220 and 230 described above with respect to FIG. 2. The cover lens 240 is provided on the second electrodes 230 used in detecting sensing signals, to receive a touch interaction from a touching object 250 such as a finger.

When driving signals are applied to the first electrodes 220 through the channels D1 to D8, mutual-capacitance is generated between the first electrodes 220, to which the driving signals are applied, and the second electrodes 230. When driving signals are applied to the first electrodes, a change in mutual-capacitance occurs. The change in the mutual-capacitance may be proportional to the area of the touching object 250. In FIG. 3, the mutual-capacitance generated between first electrodes 220 connected to channels D2 and D3, respectively, and a second electrode 230 is affected by the touching object 250.

FIG. 4 is a diagram illustrating a touchscreen device according to an exemplary embodiment in the present disclosure.

Referring to FIG. 4, the touchscreen device according to the exemplary embodiment may include a panel unit 310, a driving circuit unit 320, a sensing circuit unit 330, a signal conversion unit 340, and an operation unit 350. The driving circuit unit 320, the sensing circuit unit 330, the signal conversion unit 340, and the operation unit 350 may be implemented as a single integrated circuit (IC).

The panel unit 310 may include rows of first electrodes (driving electrodes) X1 to Xm extending in a first axis direction (that is, the horizontal direction of FIG. 4), and columns of second electrodes (sensing electrodes) Y1 to Yn extending in a second axis direction (that is, the vertical direction of FIG. 4) crossing the first axis direction. Node capacitors C11 to Cmn are the equivalent representation of mutual-capacitance generated at intersections of the first electrodes X1 to Xm and the second electrodes Y1 to Yn.

The driving circuit unit 320 may apply predetermined driving signals to the first electrodes X1 to Xm of the panel unit 310. The driving signals may be square wave signals, sine wave signals, triangle wave signals, or the like, having specific frequency and amplitude. The driving circuit unit 320 includes a plurality of driving signal generation circuits so as to apply driving signals to the first electrodes X1 to Xm simultaneously. Further, the first electrodes X1 to Xm may be grouped so that the driving signals may be applied thereto sequentially.

The sensing circuit unit 330 may detect capacitance of the node capacitors C11 to Cmn from the second electrodes Y1 to Yn so as to output sensing signals. The sensing circuit unit 330 may include a plurality of C-V converters 335, each of which has at least one operational amplifier and at least one capacitor and is connected to the respective second electrodes Y1 to Yn.

The C-V converters 335 may convert the capacitance of the node capacitors C11 to Cmn into voltage signals so as to output sensing signals in an analog form. For example, each of the C-V converters 335 may include an integration circuit to integrate capacitance values. The integration circuit may integrate and convert capacitance values into a voltage value to output it.

Although the C-V converter 335 shown in FIG. 4 has the configuration in which a capacitor CF is disposed between the inverting input terminal and the output terminal of an operational amplifier, it is apparent that the circuit configuration may be altered. Moreover, each of the C-V converters 335 shown in FIG. 4 has one operational amplifier and one capacitor, it may have a number of operational amplifiers and capacitors.

When driving signals are applied to the first electrodes X1 to Xm, capacitance may be detected simultaneously from the second electrodes, the number of required C-V converts 335 is equal to the number of the second electrodes Y1 to Yn, i.e., n.

The signal conversion unit 340 may generate a digital signal S_{D} from the sensing signals output from the sensing circuit unit 330. For example, the signal conversion unit 340 may include a time-to-digital converter (TDC) circuit measuring a time at which the analog signals in the form of voltage output from the sensing circuit unit 330 reach a predetermined reference voltage level to convert the measured time into the digital signal S_{D}, or an analog-to-digital converter (ADC) circuit measuring an amount by which a level of the analog signals output from the sensing circuit unit 330 is changed for a predetermined time to convert the changed amount into the digital signal S_{D}.

The operation unit 350 may determine an occurrence of a touch interaction on the panel unit 310 based on the digital signal S_{D}. The operation unit 350 may determine the number of touch interactions, coordinates of the touch interactions, and the type of gesture of the touch interactions or the like made on the panel unit 310, based on the digital signal S_{D}.

The digital signal S_{D}, which is used by the operation unit 350 to determine whether a touch interaction has occurred, may be data that is a numerical value representing changes in capacitance of the capacitors C11 to Cmn, especially representing a difference between the capacitance with and without a touch interaction. Typically in a capacitive type touchscreen device, a region touched by a conductive object has less capacitance than other regions not touched.

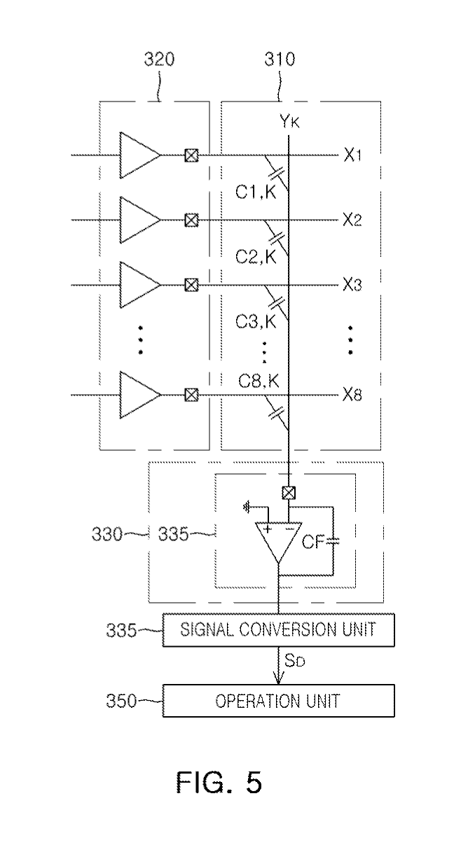

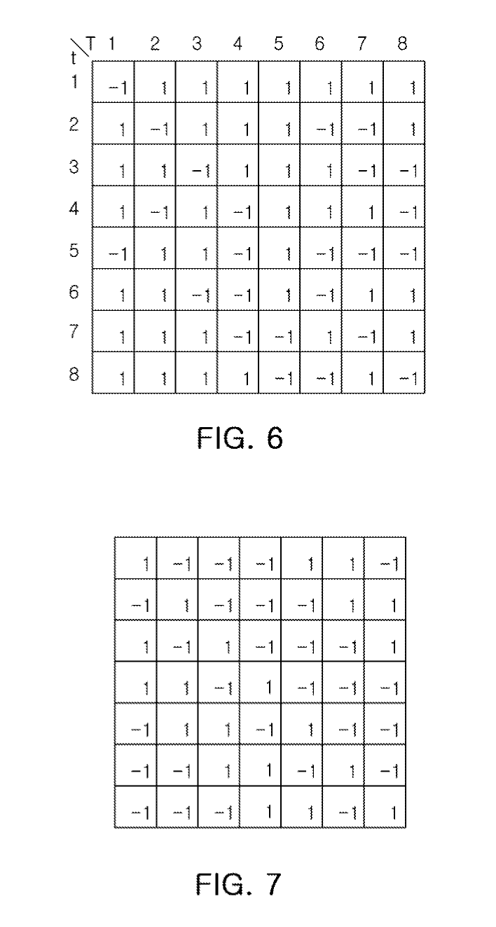

FIG. 5 is a diagram schematically showing the touchscreen device according to the exemplary embodiment shown in FIG. 4; and FIG. 6 is a driving matrix for generating driving signals according to an exemplary embodiment in the present disclosure. Hereinafter, the driving matrix according to the exemplary embodiment will be described in detail with reference to FIGS. 4 through 6.

The driving circuit unit 320 may apply voltage VDD for elements indicated by “1” and may apply voltage −VDD for elements indicated by “−1” among the elements in the matrix of 8 by 8 shown in FIG. 6. Alternatively, the driving circuit unit 320 may apply a voltage for the elements indicated by 1 and a voltage having the phase difference of 180 degrees for those indicated by −1, respectively.

The driving signals associated with the elements in the matrix of 8 by 8 shown in FIG. 6 may be applied simultaneously at intervals T1 to T8. The driving circuit unit 320 may apply the driving signals repeatedly with the intervals T1 to T8 as one period.

The driving signals generated in association with the elements in the first to eighth rows may be applied to the first electrodes X1 to X8, respectively, and the driving signals generated in association with the elements in the first to eighth columns may be simultaneously applied to the first electrodes X1 to X8 at intervals T1 to T8.

In the foregoing descriptions, it is assumed that there are eight first electrodes Xt on the panel unit 310, where t is 1 to 8, and the driving circuit unit 320 applies the driving signals to all of the first electrodes X1 to X8 simultaneously. When there is a plurality of first electrodes, for example, eighty first electrodes, it may also be possible to divide the eighty first electrodes into ten groups in each of which eight first electrodes exist, so that the driving circuit unit 320 may apply the driving signals sequentially group by group.

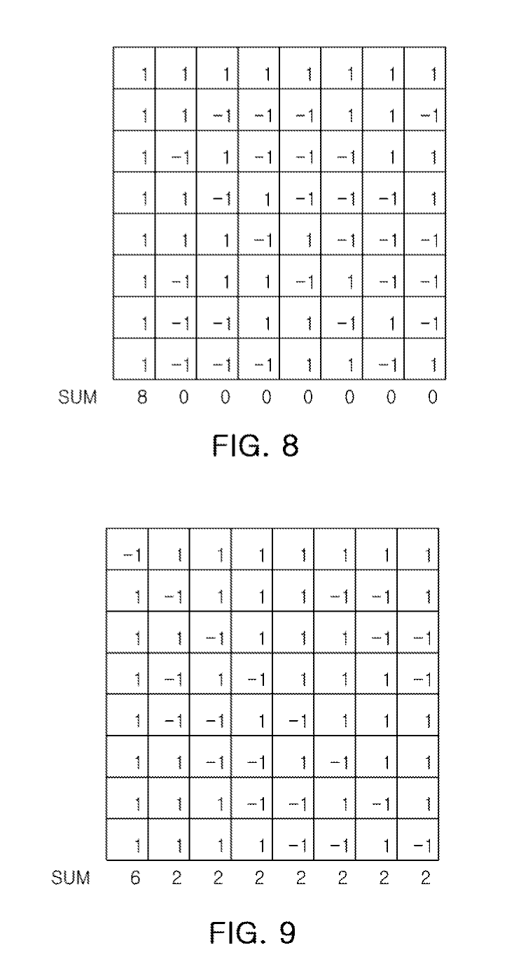

FIGS. 7 through 9 are diagrams for illustrating a process to create a basic matrix according to an exemplary embodiment in the present disclosure. The driving matrix shown in FIG. 6 may be created by changing elements in some rows and columns of the basic matrix shown in FIG. 9.

Referring to FIG. 7, the elements in the first row represent an example of a maximum length sequence which is well known, and the elements in the second to seventh rows are created by shifting the elements in the first row by one bit sequentially.

The elements in the first to eighth rows represent examples of various maximum length sequences, and it is apparent that the elements in the first to eighth rows may be changed according to examples of various maximum length sequences.

Furthermore, although the elements in a row in FIG. 7 are shifted to the direction in which the order of the columns ascends as the order of the rows increases, the elements in a row may also be shifted to the direction in which the order of the columns descends as the order of the rows increases. Further, although the length of the maximum length sequence is 7 in FIG. 7, it is apparent that the code length of the maximum length sequence may be changed.

Now, referring to FIG. 8, it can be seen that a first row and a first column are newly added to the matrix in FIG. 7, in which all of the elements are 1s. When driving signals are applied according to the matrix shown in FIG. 8, the sum of driving signals applied at the first interval, i.e., the sum of elements in the first column is quite different from the sum of driving signals applied at other intervals, i.e., the sums of elements in the second to eighth columns. As s result, there is a problem in that the peak of the sums of elements in the columns is quite different from the average. The same problem may be found in a Hadamard matrix created according to a Walsh sequence.

In order to detect capacitance generated at the first interval, the sensing circuit unit 330 needs to have large capacitors and the signal conversion unit 340 needs to have a high-resolution analog-to-digital converter, and therefore manufacturing cost increases and the volume of the device becomes larger.

In order to solve such problems, referring to FIG. 9, the maximum length sequence elements in FIG. 8, i.e., the elements in the second to eighth columns of the second to eighth rows and the element in the first column of the first row may be inverted to create a basic matrix.

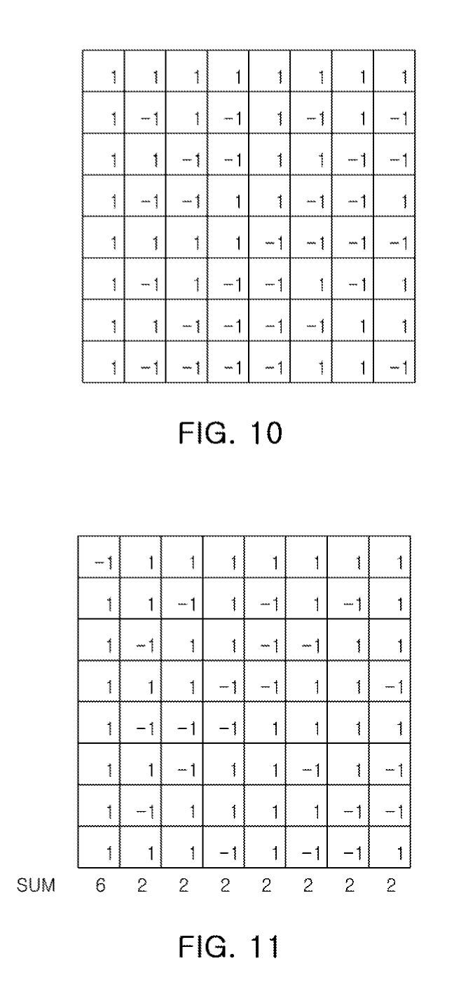

FIGS. 10 and 11 are diagrams for illustrating a process to create a basic matrix according to another exemplary embodiment in the present disclosure. The driving matrix shown in FIG. 6 may be created by changing elements in some rows and columns of the basic matrix shown in FIG. 11.

The matrix shown in FIG. 10 is a Hadamard matrix created according to a Walsh sequence; and the matrix shown in FIG. 11 is a basic matrix created by inverting some of elements of the Hadamard matrix shown in FIG. 10.

Specifically, by inverting an element in the first column of the first row and elements in the second to eighth columns of the second to eighth rows of the Hadamard matrix, the matrix shown in FIG. 11 can be created.

In the foregoing descriptions, the matrix shown in FIG. 11 is created according to a Walsh sequence having a code length of 8. However, it is merely illustrative and the Walsh sequence may have different code lengths.

Referring to the matrices shown in FIGS. 9 and 11, the sum of elements in the first column is six while the sum of elements in each of other columns is two. Accordingly, it can be seen that there still is a large difference between the peak and the average of the sums of elements in the columns.

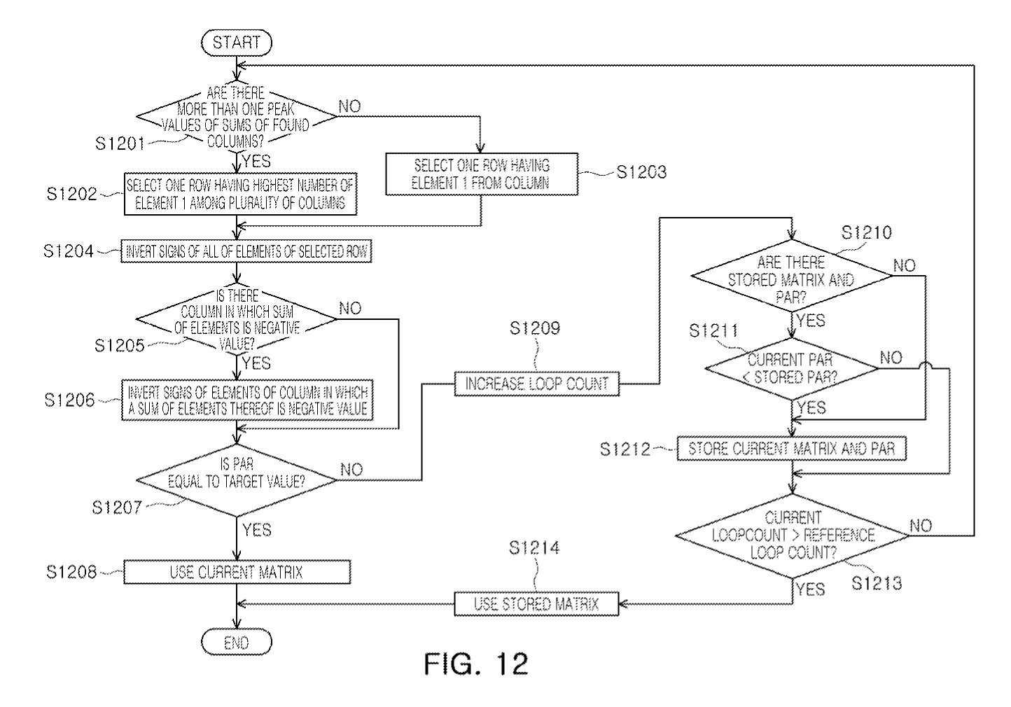

FIG. 12 is a flow chart for illustrating a method of generating driving signals according to an exemplary embodiment in the present disclosure. The method of generating driving signals according to this exemplary embodiment may be applied to various types of matrices for generating driving signals, as well as the basic matrices shown in FIGS. 9 and 11.

Referring to FIG. 12, the method of generating driving signals according to this exemplary embodiment starts with finding the peak of the sums of elements in columns, i.e., the sums of elements in each column of a matrix, and determining whether there are more than one peaks (S1201).

When there is more than one peak, a row having the highest number of maximum levels (elements of 1) is selected among a plurality of columns in which sums of elements thereof are the peaks (S1202). For example, when the sums of elements in the first, third and the fifth columns are the peaks, a common row having the highest number of elements of 1 is selected from among rows of the first, third and fifth columns. For example, when the element in the third row of the first column, the element in the third row of the third column, and the element in the third row of the fifth column are 1s, respectively, the third row may be selected.

In addition to the third row, when the element in the seventh row of the first column, the element in the seventh row of the third column, and the element in the seventh row of the fifth column are 1s, respectively, the third row or the fifth row may be selected.

When there is only one peak, a row having an element of 1 is selected from the rows of a column in which a sum of elements thereof is the peak (S1203). For example, when the sum of elements in the seventh column is the peak, a row may be selected that has an element of 1 from a plurality of elements in the seventh column.

Once a row is selected in operations S1202 and S1203, the levels (signs) of the elements in the selected row may be inverted (S1204). For example, when the third row is selected, the signs of all of the elements in the third row may be inverted.

Once the signs of all of the elements in the selected row are inverted, it is determined whether there is a column in which a sum of elements thereof is a negative value (S1205).

When there is a column in which a sum of elements thereof is a negative value, the signs of all of the elements in the column are inverted (S1206), and a PAR (the peak of the sums of elements in the column/the average of the sums of the column) is compared to a target value (S1207). Alternatively, when there is no column in which a sum of elements thereof is a negative value, the matrix is not changed, and a PAR is compared to a target value (S1207). For example, the target value may be one.

In operation S1207, when the PAR is equal to the target value, the current matrix may be used to generate driving signals (S1208). On the contrary, when the PAR is not equal to the target value, a loop count may be incremented (S1209). For example, when an initial loop count is one, it can be increased to two.

After the loop count is incremented, it is determined whether there is a stored matrix (S1210). When there is a stored matrix, the PAR of the current matrix may be compared with the PAR of the stored matrix (S1211). When the PAR of the current matrix is smaller than the PAR of the stored matrix, the current matrix may be stored (S1212). Namely, the current matrix is stored to update the stored matrix.

Alternatively, when the stored matrix is not present, the current matrix may be stored immediately (S1212).

When the current matrix is stored in operation S1212, or when the current PAR is larger than the stored PAR in operation S1211, the current loop count may be compared with a reference loop count (S1213). When the current loop count is larger than the reference loop count, the stored matrix may be used to generate driving signals (S1214). When the current loop count is smaller than the reference loop count, the stored matrix may be used to update a basic matrix to perform operation S1201 repeatedly.

Table 1 below shows simulation data obtained by applying a method of generating driving signals according to an exemplary embodiment in the present disclosure.

Comparative Example 1 is performed with an existing maximum length sequence/Walsh sequence. Example 1 is performed with a method of generating driving signals according to an exemplary embodiment in the present disclosure applied to a Walsh sequence. Example 2 is performed with a method of generating driving signals according to an exemplary embodiment in the present disclosure applied to the basic matrices shown in FIGS. 9 and 11.

For each of the examples, PARs (the peak of the sums of elements in the column/the average of the sums of elements in the column) of a matrix, and reduction percentage of the PARs in Examples 1 and 2 relative to Comparative Example 1 can be calculated as below:

TABLE 1

| | Comparative | Example 1 | | Example 2 | |
|---|---|---|---|---|---|
| Code | Example: | | Reduction | | Reduction |
| Length | PAR | PAR | (%) | PAR | (%) |
| 4 | 4/1 = 4 | 2/2 = 1 | 75% | 2/2 = 1 | 75% |
| 8 | 8/1 = 8 | 4/2 = 2 | 75% | 4/2 = 2 | 75% |
| 16 | 16/1 = 16 | 8/2 = 4 | 75% | 4/4 = 1 | 94% |
| 32 | 32/1 = 32 | 16/2 = 8 | 75% | 8/4 = 2 | 94% |

When the driving circuit unit 320 applies driving signals to a plurality of first electrodes according to a method of generating driving signals according to an exemplary embodiment in the present disclosure, the sensing circuit unit 330 detects capacitance generated at intersections of the first electrodes X1 to X8 and the second electrode Yk from the second electrode Yk so as to output a sensing signal Sk, which may be expressed by Mathematical Expression 1 below:

Sk=Σₜ₌₁⁸Ct,k*Dt [Mathematical Expression 1]

Where the term C_{t, k} denotes mutual-capacitance generated at the intersection of a first electrode Xt and a second electrode Yk. The term Dt denotes a driving signal applied to the first electrode Xt.

Assuming that there are m first electrodes, Mathematical Expression 1 may be expanded as Mathematical Expression 2 below:

Sk=Σₜ₌₁^{m}Ct,k*Dt [Mathematical Expression 2]

Then, the operation unit 350 may determine an occurrence of a touch interaction using the sensing signal Sk as sensing data. Specifically, the operation unit 350 may determine whether a touch interaction has occurred, based on the sensing signal Sk by performing correlation operation between the sensing signal Sk per cycle and driving signals per cycle.

As set forth above, according to exemplary embodiments of the present disclosure, driving signals are applied to driving electrodes simultaneously, so that a touch response speed can be improved.

Further, according to exemplary embodiments of the present disclosure, deviations in the sums of driving signals applied at different intervals are corrected so that manufacturing cost can be saved and the volume can be reduced.

While exemplary embodiments have been shown and described above, it will be apparent to those skilled in the art that modifications and variations could be made without departing from the scope of the present invention as defined by the appended claims.

What is claimed is:

1. A touchscreen device comprising:
a driving circuit unit simultaneously applying predetermined driving signals to N first electrodes among a plurality of first electrodes on a panel unit, where N is a natural number equal to or greater than two;
a sensing circuit unit detecting levels of capacitance from a plurality of second electrodes on the panel unit to output sensing signals; and
an operation unit determining an occurrence of a touch interaction, based on the sensing signals,
wherein the driving circuit unit is configured to determine at least one column in which a sum of elements thereof is equal to a peak value among columns of an N-by-N basic matrix, select one row having a highest number of elements having a maximum level from rows of the determined at least one column, then create a first matrix by inverting levels of elements in the selected one row, and generate the driving signals according to a driving matrix created based on the first matrix.

2. The touchscreen device of claim 1, wherein, in the basic matrix, an element in a first column of a first row is a −1, elements in second to Nth columns of the first row are 1s, elements in second to Nth rows of the first column are 1s, and elements in the second to Nth columns of the second to Nth rows are created according to a maximum length sequence.

3. The touchscreen device of claim 2, wherein elements in the second to Nth columns of the second row of the basic matrix are created by inverting codes according to the maximum length sequence, and elements in the second to Nth columns of the third to Nth rows are created by shifting elements in the second to Nth columns of the second row by one bit for every row.

4. The touchscreen device of claim 1, wherein the basic matrix is created by inverting a level of an element in a first column of a first row and levels of elements in second to eighth columns of second to Nth rows of an N-by-N Hadamard matrix created according to a Walsh sequence.

5. The touchscreen device of claim 1, wherein the driving circuit unit applies driving signals generated according to one column of the driving matrix to the N first electrodes at the same interval and applies driving signals generated according to one row of the driving matrix to one first electrode at different intervals.

6. The touchscreen device of claim 1, wherein the driving circuit unit applies driving signals generated according to N columns of the driving matrix at N different intervals.

7. The touchscreen device of claim 1, wherein the operation unit determines the occurrence of the touch interaction, based on a correlation value during one period calculated by performing a correlation operation between the sensing signals acquired for one period of the driving signals and the driving matrix.

8. The touchscreen device of claim 1, wherein the driving circuit unit determines the first matrix as a second matrix when a column in which a sum of elements thereof is a negative value is not present among columns of the first matrix.

9. The touchscreen device of claim 1, wherein when at least a column in which a sum of elements thereof is a negative value is present among the columns of the first matrix, the driving circuit unit creates a second matrix by inverting the elements of the at least one column in which the sum of elements thereof is a negative value.

10. The touchscreen device of claim 8, wherein the driving circuit unit compares a PAR (a peak of sums of elements in columns/an average of sums of elements in columns) of the second matrix with a target value.

11. The touchscreen device of claim 10, wherein the driving circuit unit determines the second matrix as the driving matrix when the PAR of the second matrix is equal to the target value.

12. The touchscreen device of claim 10, wherein the driving circuit unit increases a loop count when the PAR of the second matrix is different from the target value, and stores the second matrix when a stored matrix is not present.

13. The touchscreen device of claim 10, wherein the driving circuit unit increases a loop count when the PAR of the second matrix is different from the target value, compares the PAR of the second matrix with the PAR of a stored matrix when a stored matrix is present, stores the second matrix when the PAR of the stored matrix is larger than the PAR of the second matrix as a result of the comparison, to update the stored matrix, and maintains the stored matrix when the PAR of the stored matrix is not lager than the PAR of the second matrix.

14. The touchscreen device of claim 12, wherein the driving circuit unit compares the loop count with a reference loop count, and determines the stored matrix as the driving matrix when the loop count is larger than the reference loop count as a result of the comparison.

15. The touchscreen device of claim 12, wherein the driving circuit unit compares the loop count with a reference loop count, and updates the basic matrix using the stored matrix when the loop count is not larger than the reference loop count as a result of the comparison.

16. A method of generating a driving signal, the method comprising:
determining at least one column in which a sum of elements thereof is equal to a peak value among columns of an N-by-N basic matrix, and selecting one row having a highest number of elements having a maximum level from the determined at least one column;
creating a first matrix by inverting levels of elements in the selected one row;
creating a driving matrix from the first matrix; and
generating a driving signal according to the driving matrix.

17. The method of claim 16, wherein, in the basic matrix, an element in a first column of a first row is −1, elements in second to Nth columns of the first row are 1s, elements in second to Nth rows of the first column are 1s, and elements in the second to Nth columns of the second to Nth rows are created according to a maximum length sequence.

18. The method of claim 17, wherein elements in the second to Nth columns of the second row of the basic matrix are created by inverting codes according to the maximum length sequence, and elements in the second to Nth columns of the third to Nth rows are created by shifting elements in the second to Nth columns of the second row by one bit for every row.

19. The method of claim 16, wherein the basic matrix is created by inverting a level of an element in a first column of a first row and levels of elements in second to eighth columns of second to the Nth rows of an N-by-N Hadamard matrix created according to a Walsh sequence.

20. The method of claim 16, wherein the creating of the driving matrix includes determining whether a column in which a sum of elements thereof is a negative value is present among columns of the first matrix.

21. The method of claim 20, wherein the creating of the driving matrix includes determining the first matrix as a second matrix when there is no column in which a sum of elements thereof is a negative value among the columns of the first matrix.

22. The method of claim 20, wherein the creating of the driving matrix includes inverting elements in at least one column in which a sum of the elements is a negative value to create a second matrix when there is at least one column in which a sum of the elements is a negative value among the columns of the first matrix.

23. The method of claim 21, wherein the creating of the driving matrix includes comparing a PAR (a peak of sums of columns/an average of sums of columns) of the second matrix with a target value.

24. The method of claim 23, wherein the creating of the driving matrix includes determining the second matrix as the driving matrix when the PAR of the second matrix is equal to the target value.

25. The method of claim 23, wherein the creating of the driving matrix includes incrementing a loop count when the PAR of the second matrix is not equal to the target value.

26. The method of claim 25, wherein the creating of the driving matrix includes determining whether a stored matrix is present.

27. The method of claim 26, wherein the creating of the driving matrix includes storing the second matrix when the stored matrix is not present.

28. The method of claim 26, wherein the creating of the driving matrix includes comparing the PAR of the second matrix with the PAR of the stored matrix when the stored matrix is present.

29. The method of claim 28, wherein the creating of the driving matrix includes storing the second matrix to update the stored matrix when the PAR of the stored matrix is larger than the PAR of the second matrix.

30. The method of claim 28, wherein the creating of the driving matrix includes maintaining the stored matrix when the PAR of the stored matrix is not larger than the PAR of the second matrix.

31. The method of any one of claim 27, wherein the creating of the driving matrix includes comparing the loop count with a reference loop count.

32. The method of claim 31, wherein the creating of the driving matrix includes determining the stored matrix as the driving matrix when the loop count is larger than the reference loop count.

33. The method of claim 31, wherein the creating of the driving matrix includes updating the basic matrix using the stored matrix when the loop count is not larger than the reference loop count.

34. A method of creating a driving matrix, the method comprising:
creating a first matrix by inverting elements in one row depending on sums of elements in columns of an N-by-N basic matrix;
creating a second matrix from the first matrix by determining whether a column in which a sum of elements thereof is a negative value is present among columns of the first matrix; and
determining the second matrix as a driving matrix depending on sums of elements in columns of the second matrix.

35. The method of claim 34, wherein the creating of the first matrix includes:
determining at least one column in which a sum of elements thereof is equal to a peak value among columns of the basic matrix, and selecting one row having a highest number of elements having a maximum level from the determined at least one column; and
creating the first matrix by inverting levels of elements in the selected one row.

36. The method of claim 34, wherein the creating of the second matrix includes determining the first matrix as the second matrix when a column in which a sum of elements thereof is a negative value is not present among the columns of the first matrix, and inverting elements in at least one column in which a sum of elements thereof is a negative value to create the second matrix when the at least one column in which the sum of the elements thereof is a negative value among the columns of the first matrix.

37. The method of claim 34, wherein the determining of the second matrix as the driving matrix includes comparing a PAR (a peak of sums of columns/an average of sums of columns) of the second matrix with a target value.

38. The method of claim 37, wherein the determining of the second matrix as the driving matrix includes determining the second matrix as the driving matrix when the PAR of the second matrix is equal to the target value.

39. The method of claim 37, wherein the determining of the second matrix as the driving matrix includes incrementing a loop count when the PAR of the second matrix is not equal to the target value, and determining whether a stored matrix is present.

40. The method of claim 39, wherein the determining of the second matrix as the driving matrix includes:
storing the second matrix when the stored matrix is not present; and
comparing the PAR of the second matrix with the PAR of the stored matrix when the stored matrix is present, and storing the second matrix when the PAR of the stored matrix is larger than the PAR of the second matrix to update the stored matrix, while maintaining the stored matrix when the PAR of the stored matrix is not lager than the PAR of the second matrix.

41. The method of claim 40, wherein the determining of the second matrix as the driving matrix includes comparing the loop count with a reference loop count.

42. The method of claim 41, wherein the determining of the second matrix as the driving matrix includes determining the stored matrix as the driving matrix when the loop count is larger than the reference loop count.

43. The method of claim 41, wherein the determining of the second matrix as the driving matrix includes updating the basic matrix using the stored matrix when the loop count is not larger than the reference loop count.

44. A method of sensing a touch interaction, the method comprising:
applying driving signals generated according to the driving matrix of claim 34 to N first electrodes among a plurality of first electrodes, where N is a natural number equal to or greater than two;
obtaining sensing signals from second electrodes intersecting the plurality of first electrodes; and
determining an occurrence of a touch interaction by calculating a correlation value between the sensing signals and the driving signals.

45. The method of claim 44, wherein the applying of the driving signals includes applying driving signals generated according to N rows of the driving matrix to the N first electrodes simultaneously.

46. The method of claim 44, wherein the applying of the driving signals includes applying driving signals generated according to N columns of the driving matrix at different N intervals.

47. The method of claim 44, wherein the determining of the occurrence of the touch interaction includes determining an occurrence of the touch interaction, based on a correlation value calculated by performing a correlation operation between the sensing signals acquired during one period of the driving signals and the driving matrix.
